(19) United States
(12) Patent Application Publication
(10) Pub. No.: US 2004/0020324 A1
(43) Pub. Date: Feb. 5, 2004

(54) Pedal lever assembly for a motor vehicle

(76) Inventors: Howard Malcolm Jemmeson, Chelmsford (GB); Neil Jason Bowden, Taunton (GB)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/628,183

(22) Filed: Jul. 28, 2003

(30) Foreign Application Priority Data
Jul. 26, 2002 (GB) 0217324.3

(51) Int. Cl. G05G 1/14

(52) U.S. Cl. 74/512

(57) ABSTRACT

A pedal assembly 6 for a motor vehicle is disclosed in which, in a preferred embodiment, a pedal lever in the form of a brake pedal is constructed as two separate pieces, a primary lever 7 and a secondary lever 8 pivotally connected by a pivot rod 9 to a deformable part 4 of the body structure of the motor vehicle. The primary lever 7 is constructed as a ‘U’ section and envelops the secondary lever 8. Both of the levers 7, 8 are attached together by a pivot 13, positioned below a brake booster pushrod 12 and are clamped together by a latching means or catcher 10.

During a crash event there is an interaction of the top of the catcher 10 and another part of the vehicle structure, such as a cross-car beam 14, that is deformed at a different rate to the part 4 to which the two levers 7,8 are attached. If the crash is sufficiently severe to cause the beam 14 to contact the catcher 10 then it causes the catcher 10 to pivot around the pivot rod 9 allowing the primary lever 7 to be released from the catcher 10. As the pivot 13 of the primary and secondary levers 7, 8 is lower than that of the booster pushrod 12, the primary lever 7 will rotate away from the lower leg of an operator thereby reducing potential injury to the operator.

### BACKGROUND OF THE INVENTION

This invention relates to motor vehicles and in particular to a pedal assembly for a motor vehicle and systems using same.

It is well known that when a motor vehicle is subjected to a large force such as a frontal impact, the vehicle structure and components are often displaced or deformed into the occupant area. This is potentially dangerous as it may result in injuries to the driver and passengers.

It is a particular problem that the pedal levers provided for a driver to operate the brakes or clutch have to be very rigid in order to perform their designated tasks. Such rigid structures are particularly damaging in the event of interaction with a human being and it is desirable to reduce the potential damage by reducing the stiffness of any such components likely to cause injury.

In particular, if an operator is using a pedal lever at the time of a crash there is a risk that the pedal lever will be pushed rearwards by the impact causing the included angle between the upper surface of a foot of the operator and the leg to which the foot is attached to be reduced. This reduction in angle is likely to cause injury to the ankle joint connecting the foot to the leg.

It is therefore an object of the present invention to reduce the potential injury to an operator or driver of a motor vehicle caused by a pedal lever during a frontal crash event.

### SUMMARY OF THE INVENTION

According to a first aspect of the invention there is provided a pedal lever assembly for a motor vehicle having a body structure defining a passenger compartment in which the pedal lever assembly is mounted, the lever assembly comprising a primary lever, a secondary lever and a releasable latching means to selectively fasten an upper end of the primary lever to the secondary lever, the primary lever being adapted at a lower end for movement by an operator between a rest position and an activated position and the secondary lever being pivotally connected at an upper end to part of the body structure of the motor vehicle and pivotally connected at a lower end to the primary lever and is adapted for connection to a device to be operated by the pedal lever assembly at a position between its upper and lower ends wherein the latching means is moveable between a first position in which the primary and secondary levers are fastened together so as to function as a single lever and a second position in which the primary lever is free to rotate relative to the secondary lever.

The distance between the position of the pivotal connection of the secondary lever to the primary lever and the position of pivotal connection of the secondary lever to the body structure is greater than the distance between the position at which the secondary lever is adapted for connection to the device and the pivotal connection of the secondary lever to the body structure.

The latching means may fasten the upper end of the primary lever to the secondary lever at position between the upper end of the secondary lever and the position at which the secondary lever is pivotally connected to the primary lever.

Preferably the latching means may fasten the upper end of the primary lever to the upper end of the secondary lever.

The releasable latching means may be moved from said first position to said second position by contact between part of the latching means and an adjacent part of the body structure of the motor vehicle. The part of the motor vehicle may be a beam extending across the width of the passenger compartment.

The secondary lever may be attached at its upper end to a pivot rod used to pivotally connect the secondary lever to the body structure of the motor vehicle. The pivot rod may be a cylindrical tube, e.g. made from steel. The secondary lever may be attached to the pivot rod by welding.

The latching means may be arranged in said first position to fasten the upper end of the primary lever to the secondary lever by clamping the upper end of the primary lever to the pivot rod.

The latching means may have an abutment surface for engagement with the upper end of the primary lever and at least one aperture to pivotally connect the latching means to the upper end of the secondary lever. Preferably, the at least one aperture in the latching means is arranged for engagement with the pivot rod so as to pivotally connect the latching means to the secondary lever.

Rotation of the latching means relative to the secondary lever from the first position to the second position moves the abutment surface out of engagement with the primary lever so as to allow the primary lever to rotate relative to the secondary lever.

The at least one aperture may be an elongate aperture which may be arranged to extend substantially parallel to the abutment surface.

The movement from said first position to said second position may comprise both rotation relative to the secondary lever and sliding movement of the latching means relative to the pivot pin.

Preferably, the latching means may comprise of a U-shaped member having two arms connected by a bridging portion having an inner surface forming the abutment surface, one arm having an aperture formed therein for engagement with the pivot pin on one side of the secondary lever and the other arm having an aperture formed therein for engagement with the pivot pin on an opposite side of the secondary lever so as to sandwich the primary and secondary levers between the two arms.

When the latching means is in its first position, the upper end of the primary lever may be interposed between the bridging portion of the U-shaped member and a longitudinal edge of the secondary lever.

Each of the arms may have a hand portion extending therefrom for selective abutment with an adjacent part of the body structure of the motor vehicle.

The primary lever may be formed by a U-shaped channel member which is sufficiently wide to be engaged over the secondary lever and the secondary lever may be a flat strip like member. Alternatively, the secondary lever may be formed by a U-shaped channel member which is sufficiently wide to be engaged over the primary lever and the primary lever may be a flat strip like member.

The secondary lever may be pivotally connected to the primary lever by a pivot pin engaged with respective apertures in the primary and secondary levers.

The secondary lever may be adapted for connection to a device to be operated by the pedal lever assembly by means of an aperture formed therein for co-operation with a pin used to connect the secondary lever to an input member of the device to be operated. The device to be operated may be one of a brake servo, a brake hydraulic master cylinder, a clutch hydraulic master cylinder or an engine throttle control.

According to a second embodiment of the first aspect of the invention each of the apertures is an elongate aperture.

Preferably, each of the elongate apertures is arranged to extend substantially parallel to the abutment surface.

According to an alternative embodiment of the first aspect of the invention there is provided a pedal lever assembly for a motor vehicle having a primary lever adapted at a lower end for movement by an operator between a rest position and an activated position and having an upper end releasably attached to a pivot means by a releasable latching means, the primary lever being adapted at a position between its upper and lower ends for connection to a device to be operated by the pedal lever assembly wherein the latching means is moveable between a first position in which the primary lever is fastened to the pivot means so as to permit pivotal movement of the primary lever at its upper end about the pivot means and a second position in which the primary lever is free to rotate about a position interposed between its upper an lower ends.

When the latching means is in its second position, the primary lever may be free to rotate about the position at which it is connected to the device to be operated.

The latching means may be moved to its second position when the pedal lever assembly is moved rearwards by deformation of the body structure due to an impact at the front of the motor vehicle. The deformation of the body structure may cause the latching means to be moved into contact with a part of the body structure of the motor vehicle thereby moving the latching means into its second position. The part of the body structure may be a cross vehicle beam.

According to a second aspect of the invention there is provided a fluid pressure operable system for a motor vehicle having a body structure defining a passenger compartment and an engine compartment, a fluid pressure generating device to generate pressure for one or more actuators and a pedal lever assembly in accordance with the first aspect of the invention mounted within the passenger compartment to energise the fluid pressure generating device.

The fluid pressure generating device may be mounted in the engine compartment and the pedal lever assembly is mounted in the passenger compartment and the fluid pressure generating device has an input member extending through a wall separating the engine compartment from the passenger compartment to link the pedal lever assembly to the fluid pressure generating device. The fluid may be hydraulic fluid and the at least one actuator may be a clutch slave cylinder, a brake caliper for a disc brake or a slave cylinder for a drum brake. The fluid pressure generating device may be one of a clutch master cylinder, a brake master cylinder or a brake servo.

According to a third aspect of the invention there is provided a motor vehicle having a pedal lever assembly in accordance with the first aspect of the invention.

The latching means may be releasable when the pedal lever assembly is moved rearwardly by deformation of the body structure due to an impact at the front of the motor vehicle.

The deformation of the body structure may cause the latching means to be moved into contact with a part of the body structure of the motor vehicle thereby moving the latching means into its second position. The part of the body structure may be a cross-car beam.

### BRIEF DESCRIPTION OF THE DRAWINGS

The invention will now be described by way of example with reference to the accompanying drawing of which:

FIG. 1 is a side view of a first embodiment of pedal lever assembly in accordance with the invention as applied to a brake system of a motor vehicle.

FIG. 1a is a pictorial view of an upper end of a primary lever forming part of the pedal lever assembly shown in FIG. 1.

FIG. 2 is a front view of a second embodiment of a pedal lever assembly for use in a brake system as shown in FIG. 1.

FIG. 3 is a pictorial side view of the pedal lever assembly shown in FIG. 2.

FIG. 4 is a side view of a secondary lever forming part of the pedal lever assembly shown in FIGS. 2 and 3.

FIG. 5 is a pictorial representation of the upper end of a primary lever forming part of the pedal lever assembly shown in FIGS. 2 and 3.

FIG. 6 is a view similar to FIG.1 but showing an alternative embodiment of a pedal lever assembly; and

FIG. 7 is an enlarged view of an upper end of a primary lever forming part of the pedal lever assembly shown in FIG.6 in which part of a latching means has been cut away.

### DETAILED DESCRIPTION OF THE PREFERRED EMBODIMENTS

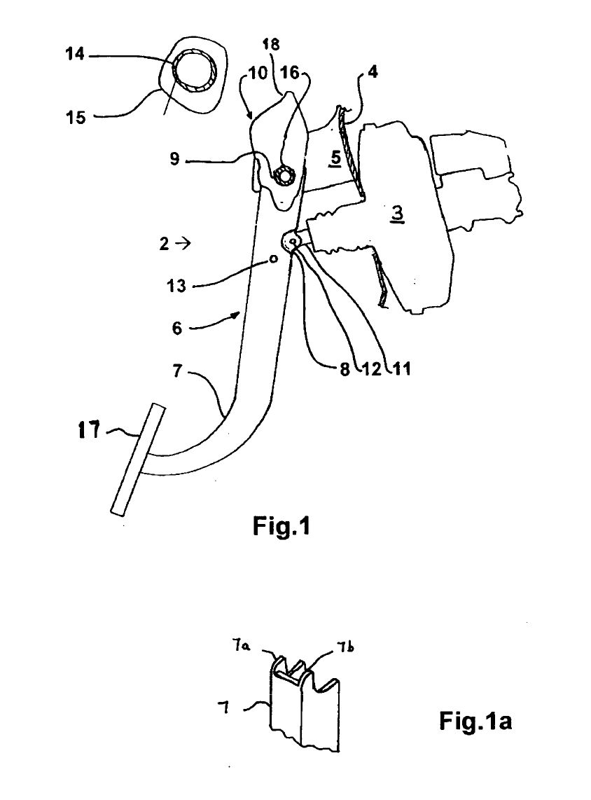

With particular reference to FIGS. 1 and 1a there is shown a scrap cross-section through part of a motor vehicle having a body structure defining a passenger compartment and an engine compartment. A fluid pressure operable system 2 for the motor vehicle has a fluid pressure generating device 3 to generate pressure for one or more actuators and a pedal lever assembly 6 mounted within the passenger compartment to energise the fluid pressure generating device 3.

The fluid pressure generating device is, in the embodiment shown and described herein, a hydraulic brake servo 3 which is mounted in the engine compartment of the motor vehicle and has an input member in the form of a pushrod 11 extending through a wall or front bulkhead 4 separating the engine compartment from the passenger compartment to link the pedal lever assembly 6 to the brake servo 3.

As is well known in the art the brake servo 3 is connected by conduits (not shown) to several actuators in the form of brake callipers (not shown) forming part of disc brakes associated with road wheels (not shown) of the motor vehicle.

However, it will be appreciated that other fluids such as compressed air could be used apart from hydraulic fluid and that the fluid pressure generating device could be a clutch master cylinder forming part of a clutch system or a brake master cylinder forming part of a braking system. In addition, it will be appreciated that in the case of a clutch system the actuator could be a clutch slave cylinder and that in the case of a braking system the at least one actuator could either be a brake caliper for a disc brake as previously mentioned or could be one or more slave cylinders for a drum brake.

Although the invention is particularly suitable for use with a fluid operable system it will be appreciated that it could be applied to any other system requiring a foot controlled input such as for example an engine throttle control.

The pedal lever assembly 6 comprises a primary lever 7, a secondary lever 8 and a releasable latching means 10 to selectively fasten an upper end of the primary lever 7 to the secondary lever 8.

The primary lever 7 has a pedal pad 17 at a lower end to adapt it for movement by an operator between a rest position and an activated position and is formed by a U-shaped channel member which is sufficiently wide to be engaged over the secondary lever 8 which is a thin flat strip like member made from steel.

The secondary lever 8 is pivotally connected at an upper end to part of the body structure of the motor vehicle in the form of a pedal box 5 connected to the front bulkhead 4 and is pivotally connected at a lower end to the primary lever 7 by means of a pivot pin 13. The secondary lever 8 has a lug formed on one longitudinal edge at a position between its upper and lower ends in which is positioned a hole to adapt the secondary lever 8 for connection by means of a pin 12 to a device such as the brake servo 3 to be operated by the pedal lever assembly 6.

The latching means 10 is moveable between a first position in which the primary and secondary levers 7 and 8 are fastened together so as to function as a single lever and a second position in which the primary lever 7 is free to rotate relative to the secondary lever 8.

The releasable latching means 10 is moved from the first position to the second position by contact between part of the latching means 10 in the form of two upwardly extending hands 18 (only one of which is shown) and an adjacent part of the body structure of the motor vehicle, which in this case is a cross-vehicle or cross-car beam 14. The cross-car beam 14 extends across the width of the passenger compartment and is attached at both ends to side walls 15 forming part of the body structure of the motor vehicle. However it will be appreciated that some other conveniently located member within the passenger compartment could be used to move the latching means.

The secondary lever 8 is attached at its upper end to a pivot rod 9 used to pivotally connect the secondary lever 8 to the pedal box 5.

The pivot rod 9 is in the form of a cylindrical steel tube to which the secondary lever 8 is attached by welding and is rotatably mounted at each end in the pedal box 5.

The latching means 10 has an abutment surface for engagement with the upper end of the primary lever 7 and two apertures 16 (only one of which is shown) to pivotally connect the latching means 10 to the upper end of the secondary lever 8.

The latching means comprises a U-shaped member 10 having two arms connected by a bridging portion, an inner surface of which forms the abutment surface. Each of the arms has one of the apertures 16 formed therein for engagement with the pivot rod 9 on one side of the secondary lever 8 so as to sandwich the primary an secondary levers 7 and 8 between the two arms.

The distance between a longitudinal axis of the pivot rod 9 and the abutment surface is slightly less than the distance between the outer surface of the primary lever 7 to the longitudinal axis of the pivot pin when the primary lever 7 is pressed up against an adjacent longitudinal edge of the secondary lever 8 and the U-shaped member 10 is in its first position.

Therefore, when the U-shaped member 10 is in the first position the bridging portion is deflected outwardly by the interference fit produced between the abutment surface and the outer surface of the primary lever 7.

As can best be seen in FIG. 1a the upper end of the primary lever 7 is radiused so as to produce two cam surfaces 7a, 7b. The cam surfaces 7a, 7b interact with the abutment surface of the U-shaped member 10 when it is moved into the first position to fasten or clamp the upper end of the primary lever 7 to the upper end of the secondary lever 8.

However, it will be appreciated that alternatively the primary lever 7 could be arranged to contact directly against the pivot rod 9 so as to fasten the upper end of the primary lever 7 to the secondary lever 8 by clamping the upper end of the primary lever 7 to the pivot rod 9.

Rotation of the U-shaped member 10 relative to the secondary lever 8 from the first position to the second position will move the abutment surface out of engagement with the outer surface of the primary lever 7 so as to allow the primary lever 7 to rotate relative to the secondary lever 8 about the position of pivotal connection formed by the pivot pin 13.

It is important that the distance between the position of the pivotal connection of the secondary lever 8 to the primary lever 7 formed by the pivot pin 13 and the position of pivotal connection formed by the pivot rod 9 of the secondary lever 8 to the pedal box 5 is greater than the distance between the position at which the secondary lever 8 is connected to the pushrod 11 of the brake servo and the pivotal connection formed by the pivot rod 9 of the secondary lever 8 to the pedal box 5. It will be noted that it is also important that the position at which the primary lever 7 is pivotally connected by the pivot pin 13 to the secondary lever 8 is closer to the pedal pad 17 than the position where the secondary lever 8 is connected to the brake servo 3. This is because such an arrangement ensures that when the U-shaped member or latching means 10 is released and the pedal pad 17 at the lower end of the primary lever 7 is pressed upon by an operator, the pedal pad 17 can move forwardly so as to relieve the pressure on the foot of an operator.

Although in the embodiment shown the latching means fastens the upper end of the primary lever 7 to the secondary lever 8 at a position between the upper end of the secondary lever 8 and the position at which the secondary lever 8 is pivotally connected to the primary lever 7 this need not be the case. However it is preferred because it allows the latching mechanism to be automatically operated without the need for any other mechanisms or systems.

During normal use the primary and secondary levers 7 and 8 are clamped together and act as a single rigid lever. By applying pressure to the pedal pad 17 an operator is able to apply an input force to the brake servo 3 via the pushrod 11 and thereby activate the brakes of the motor vehicle.

In the event of a frontal or offset frontal collision in which the front bulkhead 4 is pushed back, the pedal box 5 is also moved rearwardly allowing the hands 18 to contact the cross-car beam 14. The interaction between the cross-car beam 14 and the hands 18 will, if the pedal box 5 has been moved back a sufficient distance, cause the U-shaped member 10 to be rotated from its normal or first position to the second position.

In the second position the primary lever 7 is uncoupled from the secondary lever 8 and is free to rotate about the pivot pin 13. Because of the relative positions of the connection of the secondary lever 8 to the pushrod 11, the pivot pin 13 and the pedal pad 17, the pedal pad 17 will be moved away from the operator when the latching means formed by the U-shaped member 10 is released thereby reducing the pressure on the foot of the operator. The forward movement of the primary lever 7 will reduce the included angle between the foot and leg of the operator and consequently reduce or minimise the risk of injury to the ankle of the operator.

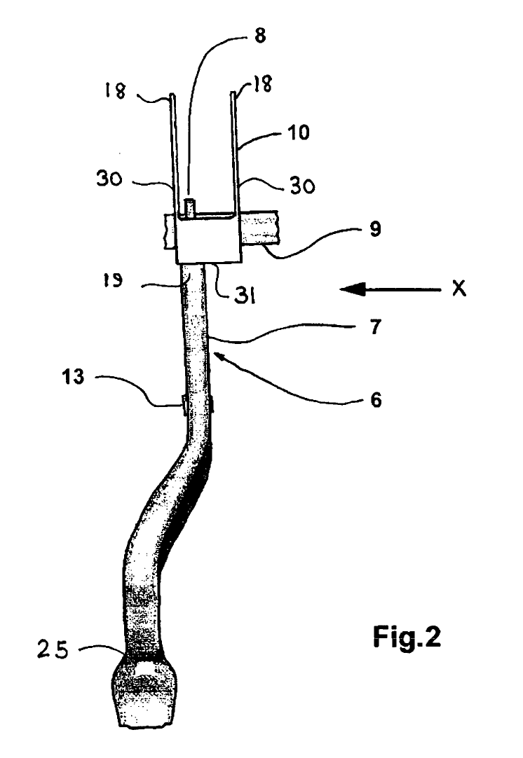

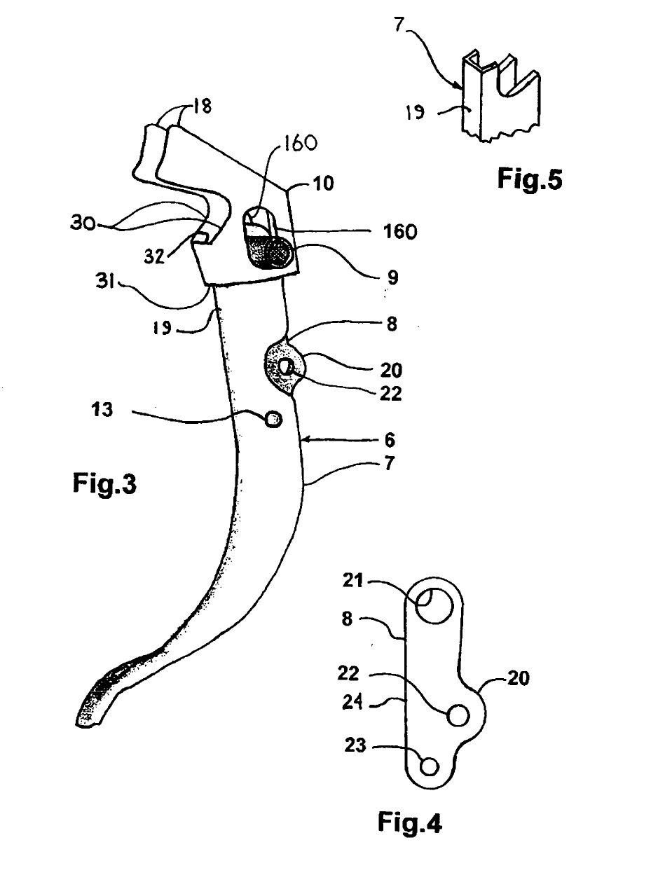

With particular reference to FIGS. 2 to 5 there is shown a second embodiment of a pedal lever assembly which is in most respects identical to that previously described and is intended to be a direct replacement for the pedal lever assembly described with reference to FIG. 1 and for which identical parts are given the same reference numerals.

The pedal lever assembly 6 comprises a primary lever 7, a secondary lever 8 and a releasable latching means 10 to selectively fasten an upper end of the primary lever 7 to the secondary lever 8.

The primary lever 7 has an aperture 25 in a lower end to attach a pedal pad which adapts it for movement by an operator between a rest position and an activated position and is formed by a U-shaped channel member which is sufficiently wide to be engaged over the secondary lever 8 which is a thin flat strip like member made from steel.

The secondary lever 8 is, as previously described, pivotally connected at an upper end to part of the body structure of the motor vehicle in the form of a pedal box connected to the front bulkhead and is pivotally connected at a lower end to the primary lever 7 by means of a pivot pin 13. The secondary lever 8 has a lug 20 formed on one longitudinal edge at a position between its upper and lower ends in which is positioned a hole 22 to adapt the secondary lever 8 for connection by means of a pin 12 to a device such as the brake servo 3 to be operated by the pedal lever assembly 6. The secondary lever 8 also has a hole 21 to accommodate a pivot rod 9 used to pivotally connect the secondary lever 8 to the pedal box and a hole 23 to accommodate the pivot pin 13.

The pivot rod 9 is in the form of a cylindrical steel tube to which the secondary lever 8 is attached by welding and is rotatably mounted at each end in the pedal box 5. The latching means 10 is moveable between a first position in which the primary and secondary levers 7 and 8 are fastened together so as to function as a single lever and a second position in which the primary lever 7 is free to rotate relative to the secondary lever 8.

The releasable latching means 10 is moved from the first position to the second position by contact between part of the latching means 10 in the form of two upwardly extending hands 18 and an adjacent part of the body structure of the motor vehicle, which, as before, is a cross-vehicle beam which extends across the width of the passenger compartment and is attached at both ends to side walls of the body structure of the motor vehicle.

The latching means 10 has an abutment surface for engagement with the upper end of the primary lever 7 and two elongate apertures 160 (only one of which is shown) to pivotally connect the latching means 10 to the upper end of the secondary lever 8.

The latching means comprises a U-shaped member 10 having two arms 30 connected by a bridging portion 31, an inner surface of which forms the abutment surface 32. Each of the arms 30 has one of the elongate apertures 160 formed therein for engagement with the pivot rod 9 on opposite sides of the secondary lever 8 so as to sandwich the primary and secondary levers 7 and 8 between the two arms 30.

The elongate apertures 160 are of substantially the same width as the diameter of the pivot rod 9 and are arranged to extend along a longitudinal axis that is substantially parallel to the abutment surface 32.

The distance between a longitudinal axis of the pivot rod 9 and the abutment surface 32 is slightly less than the distance between the outer surface 19 of the primary lever 7 to the longitudinal axis of the pivot rod 9 when the primary lever 7 is pressed up against an adjacent longitudinal edge 24 of the secondary lever 8 and the U-shaped member 10 is in its first position.

Therefore, when the U-shaped member 10 is in the first position the bridging portion 31 is deflected outwardly by the interference fit produced between the abutment surface 32 and the outer surface 19 of the primary lever 7.

The elongate apertures 160 provide in combination with the pivot rod 9 a cam arrangement used when the U-shaped member 10 is moved into the first position to fasten or clamp the upper end of the primary lever 7 to the upper end of the secondary lever 8. This is because when the U-shaped member 10 is arranged at 90 degrees to the position shown the pivot rod 9 is free to move along the elongate apertures 160 but as the U-shaped member is rotated from the second position towards the first position the pivot rod 9 has less freedom to traverse along the elongate apertures 160 and becomes trapped in the lower end of the elongate apertures 160. This movement cause the abutment surface 32 to pull the upper end of the primary lever 7 towards the longitudinal axis of the pivot rod 9 but due to the distance between the abutment surface 32 and the longitudinal axis of the pivot rod 9 an inner surface of the primary lever 7 contacts the longitudinal edge 24 of the secondary lever 8 before the U-shaped member 10 has reached its first position. The last few degrees of rotation of the U-shaped member 10 therefore causes the bridging portion 31 to be deflected as the primary lever 7 reacts against the longitudinal edge 24 of the secondary lever 8.

However, it will be appreciated that alternatively the primary lever 7 could be arranged to contact directly against the pivot pin 9 so as to fasten the upper end of the primary lever 7 to the secondary lever 8 by clamping the upper end of the primary lever 7 to the pivot rod 9.

It will also be appreciated that although it is most convenient to pivotally connect the U-shaped member to the secondary lever by interaction with the pivot rod the U-shaped lever could be pivotally connected directly to the secondary lever by means of a separate pivot pin connection.

Rotation of the U-shaped member 10 relative to the secondary lever 8 from the first position to the second position will move the abutment surface 32 out of engagement with the outer surface 19 of the primary lever 7 so as to allow the primary lever 7 to rotate relative to the secondary lever 8 about the position of pivotal connection formed by the pivot pin 13.

As previously mentioned, it is important that the distance between the position of the pivotal connection of the secondary lever 8 to the primary lever 7 formed by the pivot pin 13 and the position of pivotal connection formed by the pivot rod 9 of the secondary lever 8 to the pedal box is greater than the distance between the position at which the secondary lever 8 is connected to the pushrod of the brake servo and the pivotal connection formed by the pivot rod 9 of the secondary lever 8 to the pedal box.

It will once again be noted that it is also important that the position at which the primary lever 7 is pivotally connected by the pivot pin 13 to the secondary lever 8 is closer to the position of connection of the pedal pad than the position where the secondary lever 8 is connected to the brake servo. This is because such an arrangement ensures that when the U-shaped member or latching means 10 is released and the pedal pad at the lower end of the primary lever 7 is pressed upon by an operator, the pedal pad can move forwardly so as to relieve the pressure on the foot of an operator.

Although in this embodiment the latching means fastens the upper end of the primary lever 7 to the secondary lever 8 at a position between the upper end of the secondary lever 8 and the position at which the secondary lever 8 is pivotally connected to the primary lever 7 this need not be the case. However, it is preferred because it allows the latching mechanism to be automatically operated without the need for any other mechanisms or systems.

During normal use the primary and secondary levers 7 and 8 are clamped together and act as a single rigid lever. By applying pressure to the pedal pad connected to the lower end of the primary lever an operator is able to apply an input force to the brake servo via the pushrod and thereby activate the brakes of the motor vehicle.

In the event of a frontal or offset frontal collision in which the front bulkhead is pushed back, the pedal box is also moved rearwardly allowing the hands 18 to contact the cross-car beam. The interaction between the cross-car beam and the hands 18 will, if the pedal box has been moved back a sufficient distance, cause the U-shaped member 10 to be rotated from its normal or first position to the second position.

In addition, once moved from its first position the movement from the first position to the second position of the U-shaped member 10 may comprise of both rotation relative to the secondary lever and sliding movement of the U-shaped member relative to the pivot rod as the pivot rod slides along the elongate apertures 160.

In the second position the primary lever 7 is uncoupled from the secondary lever 8 and is free to rotate about the pivot pin 13. Because of the relative positions of the connection of the secondary lever 8 to the pushrod 11, the pivot pin 13 and the pedal pad, the pedal pad will be moved away from the operator when the latching means formed by the U-shaped member 10 is released thereby reducing the pressure on the foot of the operator. The forward movement of the primary lever 7 will reduce the included angle between the foot and leg of the operator and consequently reduce or minimise the risk of injury to the ankle of the operator.

It will be appreciated that instead of the primary lever being a U-shaped member and the secondary lever being a flat strip like member, the primary member could be a flat strip like member and the secondary lever could be a U-shaped member.

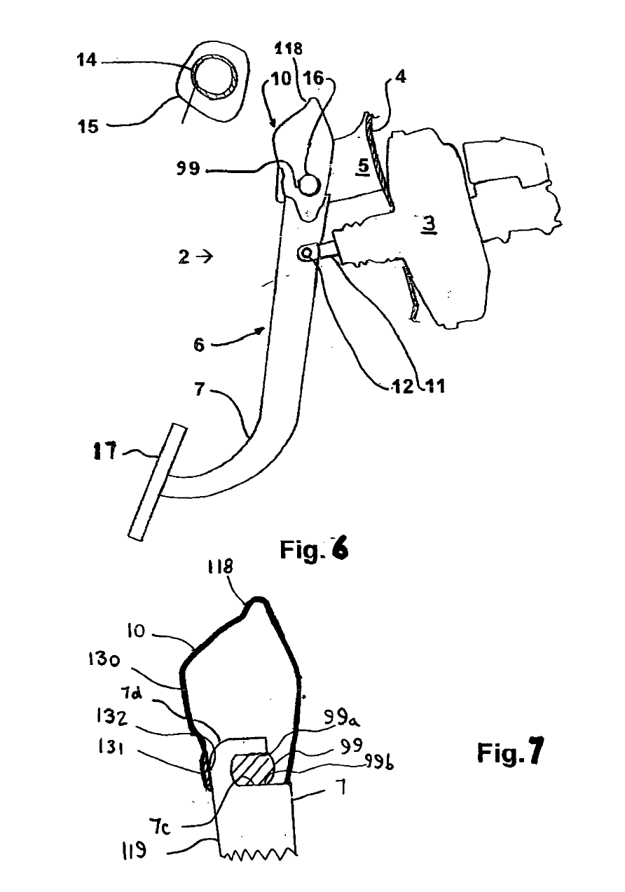

With reference to FIGS. 6 and 7 there is shown an alternative embodiment of a pedal lever assembly according to the invention similar to that previously described.

FIG. 6 shows a scrap cross-section through part of a motor vehicle similar to that shown in FIG. 1. The motor vehicle has a body structure defining a passenger compartment and an engine compartment and a pedal lever assembly 6 is mounted within the passenger compartment to energise a fluid pressure generating device 3 forming part of a fluid pressure operable system 2.

The fluid pressure operable system comprises the fluid pressure generating device in the form of a hydraulic brake booster or servo 3 to generate pressure for one or more actuators in the form of disc brakes (not shown).

The hydraulic brake servo 3 is mounted in the engine compartment of the motor vehicle and has an input member in the form of a pushrod 11 extending through a wall in the form of a front bulkhead 4 separating the engine compartment from the passenger compartment to link the pedal lever assembly 6 to the brake servo 3.

As is well known in the art the brake servo 3 is connected by conduits (not shown) to the actuators in the form of brake calipers (not shown) forming part of disc brakes associated with road wheels (not shown) of the motor vehicle.

The pedal lever assembly 6 comprises a primary lever 7 and a releasable latching means 10 to selectively fasten an upper end of the primary lever 7 to a primary pivot means in the form of a pivot rod 99.

The primary lever 7 has a pedal pad 17 attached at a lower end to adapt it for movement by an operator between a rest position and an activated position and is formed by a flat strip of steel.

The pivot rod 99 is in the form of a steel rod to which the primary lever 7 can be selectively attached by mean the latching means 10. The pivot rod 99 has two flats 99a, 99b formed thereon for engagement with a slot 7c formed in the upper end of the primary lever 7 and is rotatably mounted at each end in the pedal box 5.

The slot 7c and the flats 99a, 99b form a driveable connection between the primary lever 7 and the pivot rod 99 so as to pivotally connect the primary lever 7 at its upper end to the body structure of the motor vehicle.

The latching means 10 is moveable between a first position in which the primary lever 7 and the pivot rod 99 are fastened together so as to function as a single component and a second position in which the primary lever 7 is free to move out of engagement with the pivot rod 99.

The releasable latching means 10 is moved from the first position to the second position by contact between part of the latching means 10 in the form of two upwardly extending hands 118 and an adjacent part of the body structure of the motor vehicle in the form of a cross-vehicle beam 15 which extends across the width of the passenger compartment and is attached at both ends to side walls 15 of the body structure of the motor vehicle.

The latching means 10 has an abutment surface 132 for engagement with the upper end of the primary lever 7 and two apertures 16 (only one of which is shown) to pivotally connect the latching means 10 to the pivot rod 99.

The latching means comprises a U-shaped member 10 having two arms 130 (only one of which is shown) connected by a bridging portion 131, an inner surface of which forms the abutment surface 132. Each of the arms 130 has one of the apertures 16 formed therein for engagement with the pivot rod 99 on one side of the primary lever 7 so as to sandwich the primary lever 7 between the two arms 130.

As can best be seen in FIG. 7 the upper end of the primary lever 7 is radiused so as to produce a cam surfaces 7d. The cam surface 7d interacts with the abutment surface 132 of the U-shaped member 10 when it is moved into the first position to fasten or clamp the upper end of the primary lever 7 to the pivot rod 99.

The distance between a longitudinal axis of the pivot rod 99 and the abutment surface 132 is slightly less than the distance between an outer surface 119 of the primary lever 7 to the longitudinal axis of the pivot rod 99 when the primary lever 7 is pressed up against the pivot rod 99 and the U-shaped member 10 is in its first position.

Therefore, when the U-shaped member 10 is in the first position the bridging portion 131 is deflected outwardly by the interference fit produced between the abutment surface 132 and the outer surface 119 of the primary lever 7.

Rotation of the U-shaped member 10 relative to the primary lever 7 from the first position to the second position will move the abutment surface 132 out of engagement with the outer surface 119 of the primary lever 7 so as to allow the primary lever 7 to move relative to the pivot rod 99 about the position of connection between the primary lever 7 and the pushrod 11 formed by the pin 12.

It is important that the position of the connection of the primary lever 7 to the pushrod 11 is between the upper and lower ends of the primary lever 7 and in particular is between the pedal pad 17 and the position at which the primary lever 7 is connected to the pivot rod 99.

This is because such an arrangement ensures that when the U-shaped member or latching means 10 is released and the pedal pad 17 at the lower end of the primary lever 7 is pressed upon by an operator, the pedal pad 17 can move forwardly so as to relieve the pressure on the foot of an operator.

During normal use the primary lever 7 and the pivot rod 99 are clamped together and the primary lever 7 acts as a normal top mounted single rigid lever. By applying pressure to the pedal pad 17 connected to the lower end of the primary lever 7 an operator is able to apply an input force to the brake servo 3 via the pushrod 11 and thereby activate the brakes of the motor vehicle.

In the event of a frontal or offset frontal collision in which the front bulkhead 4 is pushed back, the pedal box 5 is also moved rearwardly allowing the hands 118 to contact the cross-car beam 14. The interaction between the cross-car beam 14 and the hands 118 will, if the pedal box 5 has been moved back a sufficient distance, cause the U-shaped member 10 to be rotated from its normal or first position to the second position.

In the second position the primary lever 7 is uncoupled from the pivot rod 99 and is free to rotate about the pin 12. Because of the relative positions of the connection of the primary lever 7 to the pushrod 11 and the pedal pad 17, the pedal pad 17 will be moved away from the operator when the latching means formed by the U-shaped member 10 is released thereby reducing the pressure on the foot of the operator by reducing the included angle between the upper surface of the foot of the operator and the leg to which the foot is attached consequently reducing the risk of injury to the ankle of the operator.

It will be appreciated that alternative embodiments can be constructed without departing from the scope of this invention as defined by the attached claims.

The invention claimed is:

1. A pedal lever assembly for a motor vehicle having a body structure defining a passenger compartment in which the pedal lever assembly is mounted, the lever assembly comprising a primary lever, a secondary lever and a releasable latching means to selectively fasten an upper end of the primary lever to the secondary lever, the primary lever being adapted at a lower end for movement by an operator between a rest position and an activated position and the secondary lever being pivotally connected at an upper end to part of the body structure of the motor vehicle and pivotally connected at a lower end to the primary lever and is adapted for connection to a device to be operated by the pedal lever assembly at a position between its upper and lower ends wherein the latching means is moveable between a first position in which the primary and secondary levers are fastened together so as to function as a single lever and a second position in which the primary lever is free to rotate relative to the secondary lever.

2. The pedal lever assembly as claimed in claim 1 in which the releasable latching means is moved from said first position to said second position by contact between part of the latching means and an adjacent part of the body structure of the motor vehicle.

3. The pedal lever assembly as claimed in claim 1 in which the secondary lever is attached at its upper end to a pivot rod used to pivotally connect the secondary lever to the body structure of the motor vehicle.

4. The pedal lever assembly as claimed in claim 3 in which the latching means has an abutment surface for engagement with the upper end of the primary lever and at least one aperture to pivotally connect the latching means to the upper end of the secondary lever.

5. The pedal lever as claimed in claim 4 in which the at least one aperture in the latching means is arranged for engagement with the pivot rod so as to pivotally connect the latching means to the secondary lever.

6. The pedal lever assembly as claimed in claim 4 in which rotation of the latching means relative to the secondary lever from the first position to the second position moves the abutment surface out of engagement with the primary lever so as to allow the primary lever to rotate relative to the secondary lever.

7. The pedal lever assembly as claimed in claim 4 in which the at least one aperture is an elongate aperture.

8. The pedal lever assembly as claimed in claim 7 in which the movement from said first position to said second position comprises both rotation relative to the secondary lever and sliding movement of the latching means relative to the pivot pin.

9. The pedal lever assembly as claimed in claim 3 in which the latching means comprises a U-shaped member having two arms connected by a bridging portion having an inner surface forming the abutment surface, one arm having an aperture formed therein for engagement with the pivot rod on one side of the secondary lever and the other arm having an aperture formed therein for engagement with the pivot rod on an opposite side of the secondary lever so as to sandwich the primary and secondary levers between the two arms.

10. The pedal lever assembly as claimed in claim 9 in which when the latching means is in its first position the upper end of the primary lever is interposed between the bridging portion of the U-shaped member and a longitudinal edge of the secondary lever.

11. The pedal lever assembly as claimed in claim 9 in which each of the apertures is an elongate aperture.

12. The pedal lever assembly as claimed in claim 11 in which each of the elongate apertures is arranged to extend substantially parallel to the abutment surface.

13. The pedal lever assembly as claimed in claim 9 in which each of the arms has a hand portion extending therefrom for selective abutment with an adjacent part of the body structure of the motor vehicle.

14. The pedal lever assembly as claimed in claim 1 in which one of the primary lever and the secondary lever is formed by a U-shaped channel member which is sufficiently wide to be engaged over the other of the secondary lever and the primary lever.

15. The pedal lever assembly as claimed in claim 1 in which one of the primary lever and the secondary lever is a flat strip like member.

16. The pedal lever assembly as claimed in claim 1 in which the secondary lever is pivotally connected to the primary lever by a pivot pin engaged with respective apertures in the primary and secondary levers.

17. The pedal lever assembly as claimed in claim 1 in which the secondary lever is adapted for connection to a device to be operated by the pedal lever assembly by means of an aperture formed therein for co-operation with a pin used to connect the secondary lever to an input member of the device to be operated.

18. The pedal lever assembly as claimed in claim 1 in which the device to be operated is one of a brake servo, a brake hydraulic master cylinder, a clutch hydraulic master cylinder or an engine throttle control.

19. A motor vehicle having a body structure defining a passenger compartment and an engine compartment, the motor vehicle further having a pedal lever assembly mounted substantially within the passenger compartment, the lever assembly comprising a primary lever, a secondary lever and a releasable latching means to selectively fasten an upper end of the primary lever to the secondary lever, the primary lever being adapted at a lower end for movement by an operator between a rest position and an activated position and the secondary lever being pivotally connected at an upper end to part of the body structure of the motor vehicle and pivotally connected at a lower end to the primary lever and is adapted for connection to a device to be operated by the pedal lever assembly at a position between its upper and lower ends wherein the latching means is moveable between a first position in which the primary and secondary levers are fastened together so as to function as a single lever and a second position in which the primary lever is free to rotate relative to the secondary lever.

20. The motor vehicle as claimed in claim 19 in which the latching means is releasable when the pedal lever assembly is moved rearwardly by deformation of the body structure due to an impact at a front of the motor vehicle.

21. The motor vehicle as claimed in claim 20 in which the deformation of the body structure causes the latching means to be moved into contact with a part of the body structure of the motor vehicle thereby moving the latching means into its second position.

22. The motor vehicle as claimed in claim 19 further comprising a fluid pressure generating device mounted in the engine compartment, the fluid pressure generating device having an input member extending through a wall separating the engine compartment from the passenger compartment to link the pedal lever assembly to the fluid pressure generating device.

23. A pedal lever assembly for a motor vehicle having a primary lever adapted at a lower end for movement by an operator between a rest position and an activated position and having an upper end releasably attached to a pivot means by a releasable latching means, the primary lever being adapted at a position between its upper and lower ends for connection to a device to be operated by the pedal lever assembly wherein the latching means is moveable between a first position in which the primary lever is fastened to the pivot means so as to permit pivotal movement of the primary lever at its upper end about the pivot means and a second position in which the primary lever is free to rotate about a position interposed between its upper and lower ends.
